(19) United States
(12) Patent Application Publication
(10) Pub. No.: US 2013/0216724 A1
(43) Pub. Date: Aug. 22, 2013

(54) ELECTRIC FIELD AUXILIARY ROBOTIC NOZZLE PRINTER AND METHOD FOR MANUFACTURING ORGANIC WIRE PATTERN ALIGNED USING SAME

(71) Applicants: Tae-Woo Lee, Pohang-si (KR); Sung Yong Min, Gwangju (KR)

(72) Inventors: Tae-Woo Lee, Pohang-si (KR); Sung Yong Min, Gwangju (KR)

(73) Assignee: POSTECH ACADEMY-INDUSTRY FOUNDATION, Pohang-si (KR)

(21) Appl. No.: 13/877,806

(22) PCT Filed: Oct. 6, 2011
(86) PCT No.: PCT/KR2011/007411

§ 371 Date: Apr. 4, 2013

(30) Foreign Application Priority Data
Oct. 7, 2010 (KR) 10-2010-0097995
Oct. 4, 2011 (KR) 10-2011-0100762

(51) Int. Cl. H01B 13/00

(52) U.S. Cl. CPC H01B 13/0026; B82Y 40/00
USPC 427/466; 118/624; 977/892

(57) ABSTRACT

Provided according to an aspect of the present disclosure is an electric field aided robotic nozzle printer including a solution storage apparatus for supplying a discharging solution; a nozzle for discharging the discharging solution supplied by the solution storage apparatus; a voltage applying apparatus for applying high voltage onto the nozzle; a flat and movable collector, in which organic wires formed after discharge from the nozzle are aligned; a robot stage, which is installed below the collector and enables to move the collector in an x-y direction (horizontal direction) within a horizontal plane; a micro distance controller for regulating the distance between the nozzle and the collector in a Z direction (vertical direction); and a base plate, which is installed below the robot stage, for maintaining flatness of the collector and preventing vibration generated during the operation of the robot stage.

### TECHNICAL FIELD

The present disclosure relates to a nozzle printer and a method of fabrication of organic wire patterns using the same, and more particularly, to an electric field aided robotic nozzle printer capable of fabricating high resolution wire patterns via an electric field and robot stage, and a method of arranging organic wire patterns in large area using the same.

### BACKGROUND ART

Until recently, inorganic nanostructures such as an inorganic semiconductor nanowire have been mainly used in developing high performance nano-scale electronic devices or photoelectronic devices. The inorganic semiconductor nanowire exhibits an excellent performance as a single stranded nanowire device. However, its commercialization has been much delayed due to the difficulty in arranging/patterning it in a large area after transferring it onto a substrate. Inorganic semiconductor nanowires may be used to develop high performance nano electronic devices with flexibility. However, organic semiconductor materials or organic-inorganic composite semiconductor materials are more preferable.

In general, organic materials are advantageous in that they are easy to synthesize, can be synthesized in large scale, enable a solution process, and are readily regulated of their molecular and electric properties via molecular designs. Therefore, the manufacturing cost of organic semiconductor materials is much less than those of inorganic semiconductor materials, and they are also more suitable for large scale production. Furthermore, organic semiconductor materials have excellent compatibility with plastic substrates. Therefore, their applicability as a device is greater than those of inorganic semiconductor materials.

Examples of fabricating organic nanowires include solution deposition, vapor transport, solvent-annealing, anodic aluminum oxide (AAO) template method, direct-tip drawing and the like. However, these methods have problems in that it is difficult to control the dimension or number of organic nanowires, and also to separate them from a matrix. Therefore, fabrication of application devices using the organic nanowires and obtaining a reproducible result using the same remain to be solved.

A method of fabricating organic nanowires that enables easy control of fabricated organic nanowire size without being buried therein is electrospinning. Electrospinning is performed such that high voltage is applied to droplets formed from a solution to be fabricated into nanowires, and when the intensity of the electric field between the droplets and the substrate becomes greater than the surface tension of the droplets, the droplets increase into a form of a thread and drop onto the substrate. Wires of about a few micrometers or submicrometers may be fabricated by this method. FIG. 1 shows a picture of organic nanowires formed on a substrate by the conventional electrospinning. The nanowires formed by electrospinning become irregularly intermingled by an unstable electric field before being attached to the substrate as shown in FIG. 1, thus enabling nanowires to be obtained in an aligned state. The conventional electrohydrodynamic jet printing, where droplets of a polymer solution are dropped via an electric field, is a drop on demand (DOD) method that cannot establish a continuous flow, and is thus unable to obtain an aligned form of nanowires. In addition, a general nozzle printing method does not aid the electric field, and a solution is released from a nozzle tip in a continuous flow only by means of pressure. Here, the solution being released is determined based on the diameter of the nozzle tip, and thus a nano-sized structure cannot be drawn and the structure being fabricated fails to show a complete shape of a wire.

### DETAILED DESCRIPTION OF THE INVENTION

### Technical Problem

The present disclosure provides an apparatus capable of forming aligned organic wire patterns of high resolution.

The present disclosure also provides a method of fabricating high resolution aligned organic wire patterns in large area by using the above apparatus.

According to an aspect of the present disclosure, there is provided an electric field aided robotic nozzle printer including:

a solution storage apparatus for supplying a discharging solution;

a nozzle for discharging the discharging solution supplied by the solution storage apparatus;

a voltage applying apparatus for applying high voltage onto the nozzle;

a flat and movable collector, in which organic wires formed after discharge from the nozzle are aligned;

a robot stage, which is installed below the collector and enables to transport the collector in an X-Y direction within a horizontal plane;

a micro distance controller for regulating the distance between the nozzle and the collector in a Z direction (vertical direction); and

a base plate, which is installed below the robot stage, for maintaining flatness of the collector and preventing vibration generated during the operation of the robot stage.

The electric field aided robotic nozzle printer may further include a discharge controller, which is connected to the solution storage apparatus, and discharges the discharging solution in the solution storage apparatus in a predetermined rate.

The discharge controller may include a pump or a gas pressure regulator, but is not limited thereto. The discharge controller can control the rate of discharging the discharging solution in the range of about 1.0 nl/min to about 50 ml/min.

The solution storage apparatus may be formed in a plurality, and a separate discharge controller may operate independently per each of the plural number of solution storage apparatuses.

The material for the solution storage apparatus may include plastic, glass and stainless steel, but is not limited thereto. The capacity of the solution storage apparatus may be in the range of about 1.0 μl to about 5,000 ml.

The nozzle may be a single nozzle, a dual-concentric nozzle, a triple-concentric nozzle, a split nozzle or a multi nozzle. The dual-concentric nozzle and the triple-concentric nozzle respectively receive the discharging solution from the plurality of the solution storage apparatuses. About 2 to about 30 of the split nozzles are aligned in a row at predetermined intervals and receive a discharging solution from a single solution storage apparatus. About 2 to about 30 of the multi nozzles aligned in a row at predetermined intervals and respectively receive the discharging solution from a plurality of the solution storage apparatuses.

The nozzle has a diameter of about 100 nm to about 1.5 mm.

The applied voltage is in the range of about 0.1 kV to about 50 kV.

The collector is grounded and has a flatness of about 0.5 μm to about 10 μm. The flatness of the base plate may be selected in the range of about 0.1 μm to about 5 μm.

The robot stage may be operated by a servo motor, and move to two different directions which are perpendicular to each other on a horizontal plane.

The robot stage is movable in the range of about 10 nm to about 100 cm. The velocity of the robot stage movement can be controlled in the range of about 1 mm/min to 60,000 mm/min.

The micro distance controller includes a jog and a micrometer, and the distance between the nozzle and the collector is controlled in the range of about 10 μm to about 20 mm.

The electric field aided robotic nozzle printer may further include a housing which encompasses the entire system including the solution storage apparatus, the nozzle, the collector, the robot stage, the micro distance controller and the base plate. The housing can block the external air and control the interior gas atmosphere of the entire system. The housing is sealable and its interior can be filled with an inert gas or dry air via a gas injector. The housing may further include a ventilator which releases the gas in the interior of the housing to the outside.

In another aspect of the present disclosure, there is provided a method of fabricating organic wire patterns. The method of fabricating organic wire patterns include,

adding an organic solution, where an organic material or organic-inorganic hybrid material is mixed with distilled water or an organic solvent, into the solution storage apparatus of the electric field aided robotic nozzle printer;

discharging the organic solution from the nozzle while applying high voltage on the nozzle by the voltage applying apparatus of the electric field aided robotic nozzle printer; and

aligning the organic wires or organic-inorganic hybrid wires formed from the organic solution being discharged from the nozzle on the substrate placed on the collector while transporting the collector.

The organic material may include a low molecular organic semiconductor material, a high molecular organic semiconductor material, a conductive polymer, an insulative polymer or mixtures thereof. The low molecular organic semiconductor material may include 6,13-bis(triisopropylsilylethynyl) pentacene (TIPS pentacene), triethylsilylethynyl anthradithiophene (TES ADT) and [6,6]-phenyl C61 butyric acid methyl ester (PCBM), but is not limited thereto. The high molecular organic semiconductor material or the conductive polymer material may include a polythiophene derivative which includes poly(3-hexylthiophene)(P3HT) and poly(3,4-ethylenedioxythiophene) (PEDOT); poly(9-vinylcarbazole) (PVK); poly(p-phenylene vinylene); polyfluorene; polyaniline; polypyrrole; and derivatives thereof; but is not limited thereto. The insulative polymer material may include polyethylene oxide (PEO), polystyrene (PS), polycaprolactone (PCL), polyacrylonitrile (PAN), poly(methyl methacrylate) (PMMA), polyimide, poly (vinylidene fluoride) (PVDF) and polyvinylchloride (PVC) but is not limited thereto.

The organic-inorganic hybrid material may selectively include a nano-sized particle, a wire, a ribbon, a rod-shaped semiconductor, a metal, a metal oxide, a precursor of a metal or metal oxide, carbon nanotube (CNT), reduced graphene oxide, graphene, graphene quantom dot, or graphite, and quantom dot where a nano-sized II-VI semiconductor particle (CdSe, CdTe, CdS and the like) forms a core.

Accordingly, organic wires or organic-inorganic hybrid wires can be formed by using the electric field aided robotic nozzle printer of the present disclosure. In the present disclosure the term “organic wires” refers to both organic wires and organic-inorganic hybrid wires.

The line spacing of the organic wires is in the range of about 10 nm to about 20 cm. In particular, the line spacing of the organic wires can be lowered to 10 nm by using micro x-y robot stage which is used in an atomic force microscope.

The organic solvent, being one used to dissolve the organic material, may include, for example, dichloroethylene, trichloroethylene, chloroform, chlorobenzene, dichlorobenzene, styrene, dimethylformamide, dimethylsulfoxide, xylene, toluene, cyclohexene, isopropyl alcohol, ethanol, acetone or mixtures thereof, but is not limited thereto.

The substrate may have a thickness of about 50 μm to about 50 mm. The substrate may include a conductive material including aluminum (Al), copper (Cu), nickel (Ni), iron (Fe), chromium (Cr), titanium (Ti), zinc (Zn), lead (Pb), gold (Au) and silver (Ag); a semiconductor material including silicon (Si), germanium (Ge) and gallium arsenide (GaAs); and an insulative polymer including glass, a plastic film and paper, but is not limited thereto.

### Advantageous Effects

In an embodiment of the present disclosure, there is provided an electric field aided robotic nozzle printer that can control the distance between the nozzles and the collector so that they are in a very close proximity and transport the collector via the high speed robot stage, thereby forming micro organic wire patterns with high resolution.

In another embodiment of the present disclosure, there is provided a method for fabricating organic wire patterns wherein aligned organic wire patterns are formed by using the electric field aided robotic nozzle printer.

The aligned organic wire patterns with high resolution can be used to fabricate nanoscale devices such as nanowire transistors and high sensitivity biosensors.

### DESCRIPTION OF THE DRAWINGS

FIG. 1 shows a picture of organic nanowires formed on a substrate by the conventional electrospinning

FIGS. 2a and 2b respectively show a schematically illustrated perspective view and a side view of an electric field aided robotic nozzle printer according to an embodiment of the present disclosure.

FIG. 3a shows a schematically illustrated cross-sectional view of a dual-concentric nozzle part.

FIG. 3b shows a schematically illustrated cross-sectional view of a triple-concentric nozzle part.

FIG. 3c shows a schematically illustrated cross-sectional view of a split nozzle part.

FIG. 3d shows a schematically illustrated cross-sectional view of a multi nozzle part.

FIG. 4 shows a flow chart illustrating a method of forming organic wire patterns according to an embodiment of the present disclosure.

FIGS. 5a and 5b respectively show an optical microscopic picture and a SEM picture of organic wire patterns formed according to Example 1.

FIG. 6a shows a picture of the arrangement of organic nanowire transistors formed according to Example 2.

FIG. 6b shows a SEM picture of the arrangement of one of the organic nanowire transistors in FIG. 6a.

FIG. 7a shows a graph illustrating the measured drain current vs. drain voltage of transistors of FIG. 6a and FIG. 6b.

FIG. 7b shows a graph illustrating the measured drain current vs. gate voltage of transistors of FIG. 6a and FIG. 6b.

FIG. 8 shows a picture of a P3HT nanowire transistor according to Example 3.

FIG. 9 shows a graph illustrating the measured drain current vs. gate voltage of the transistor of FIG. 8.

FIG. 10 shows a graph illustrating the measured drain current vs. gate voltage of the transistor according to Example 4.

### MODE OF THE INVENTION

Reference will now be made in detail to embodiments, examples of which are illustrated in the accompanying drawings, wherein like reference numerals refer to the like elements throughout. In this regard, the present embodiments may have different forms and should not be construed as being limited to the descriptions set forth herein. Accordingly, the embodiments are merely described below, by referring to the figures, to explain aspects of the present description.

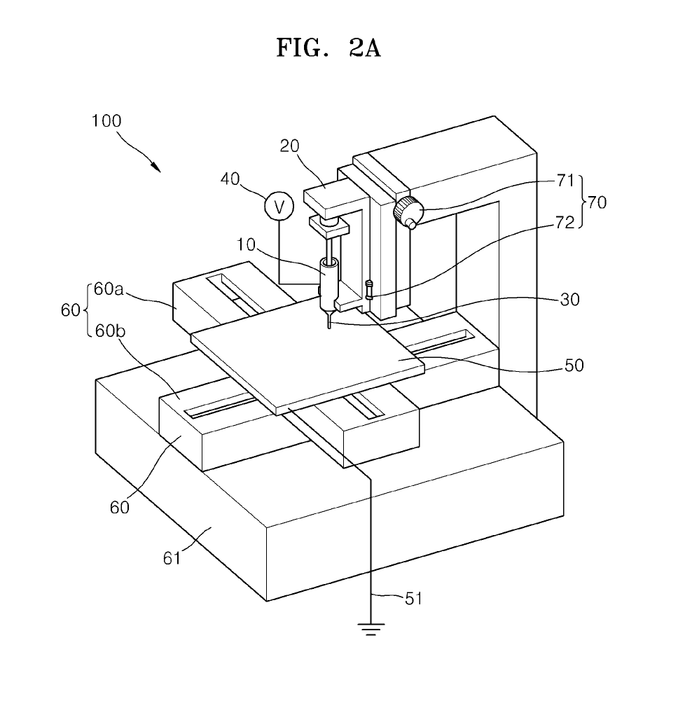

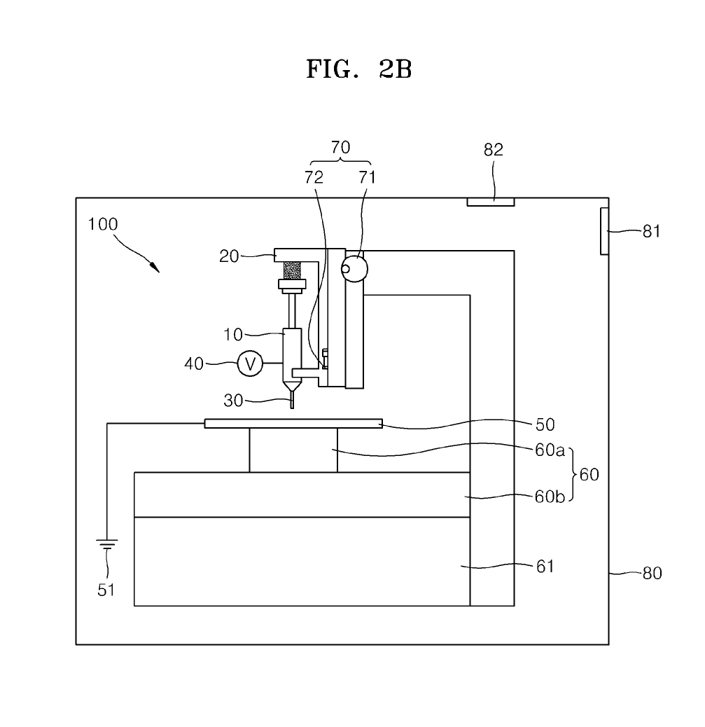

FIGS. 2a and 2b respectively show a schematically illustrated perspective view and a side view of an electric field aided robotic nozzle printer according to an embodiment of the present disclosure

Referring to FIGS. 2a and 2b, the electric field aided robotic nozzle printer (100) according to the present disclosure includes a solution storage apparatus (10), a discharge controller (20), a nozzle (30), a voltage applying apparatus (40), a collector (50), a robot stage (60), a base plate (precision stone surface) (61), and a micro distance controller (70).

The solution storage apparatus (10) stores an organic solution and supplies it to a nozzle (30) so that the organic solution can be discharged through the nozzle (30). The solution storage apparatus (10) may be in the form of a syringe. The solution storage apparatus (10) may be made by using plastic, glass or stainless steel, but is not limited thereto. The solution storage apparatus has a capacity volume in the range of about 1 μl to about 5,000 ml, but is not limited thereto. The capacity of the solution storage apparatus may be in the range of about 10 μl to about 50 ml. When the solution storage apparatus is made of stainless steel there is provided a gas injector (not shown) for injecting gas into the solution storage apparatus (10), thus enabling the discharge of the organic solution into the outside of the solution storage apparatus by using gas pressure. Meanwhile, the solution storage apparatus (10) may be formed in plurality in order to form organic wires having a core shell structure.

The discharge controller (20) serves to apply a pressure on an organic solution in the solution storage apparatus (10) to discharge the organic solution at a predetermined rate through the nozzle (30). The discharge controller (20) may be a pump or a gas pressure controller. The discharge controller (20) can control the rate of discharging the organic solution in the range of about 1 nl/min to about 50 ml/min. When more than one solution storage apparatus (10) is used, there may be provided a separate discharge controller (20) in each solution storage apparatus (10) so that each solution storage apparatus (10) can operate independently. When solution storage apparatus (10) is made of stainless steel, a gas pressure controller (not shown) may be used as a discharge controller (20).

The nozzle (30) are configured to discharge an organic solution received from the solution storage apparatus (10). The organic solution being discharged can form droplets at the terminal end of the nozzle (30). The nozzle (30) may have a diameter in the range of about 100 nm to about 1.5 mm, but are not limited thereto.

The nozzle (30) may be a single nozzle, a dual-concentric nozzle, a triple-concentric nozzle, a split nozzle or a multi nozzle. When organic wires with a core shell structure are formed, more than two different kinds of organic solutions can be discharged by using a dual-concentric nozzle or a triple-concentric nozzle. In this case, two or three solution storage apparatuses (10) may be connected to the dual-concentric nozzle or the triple-concentric nozzle.

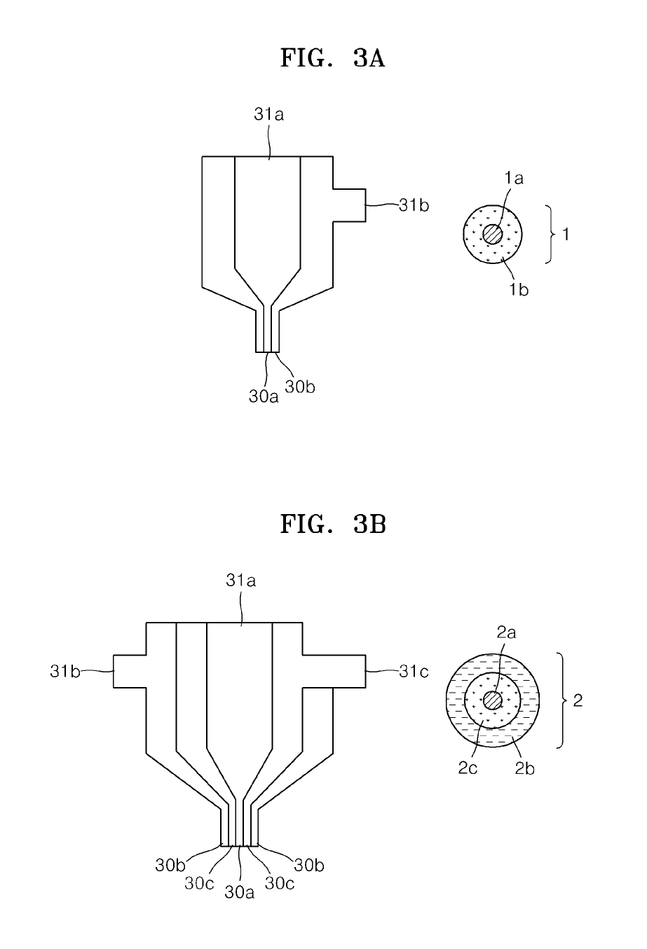

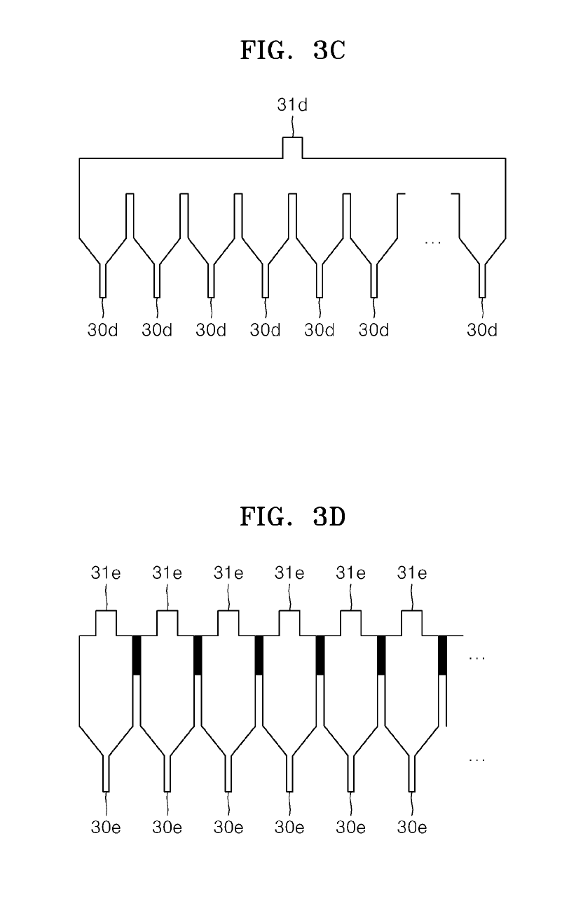

FIG. 3a shows a schematically illustrated cross-sectional view of a dual-concentric nozzle part, and FIG. 3b shows a schematically illustrated cross-sectional view of a triple-concentric nozzle part. Referring to FIG. 3a, dual-concentric nozzles (30a, 30b) are respectively connected to two solution injection inlets (31a, 31b) through which an organic solution is supplied from the solution storage apparatus. Referring to FIG. 3b, triple-concentric nozzles (30a, 30b, 30c) are respectively connected to three solution injection inlets (31a, 31b, 31c) through which an organic solution is supplied from the solution storage apparatus.

Referring to FIGS. 3a and 3b, the directions of the solution injection inlets (31a, 31b, 31c) differ from one another, and the solution injected from the solution storage apparatus can pass through a body consisting of a concentric cylinder. Each of the nozzles (30a, 30b, 30c) is connected to the terminal end of each cylinder. In the case of a dual-concentric nozzle, a core part (1a) of an organic wire can be formed from the internal nozzle (30a), and a shell part (1b) of an organic wire can be formed from the external nozzle (30b). In the case of a triple-concentric nozzle, a core part (2a) of an organic wire can be formed from the internal nozzle (30a), a shell part (2b) of an organic wire can be formed from the external nozzle (30b), and a buffer layer (2c) can be formed between the core part (2a) and the shell part (2b) from the middle nozzle (30c).

When numerous organic wires are formed in parallel, two or more organic solutions can simultaneously be discharged by using a split nozzle or a multi nozzle. In the case of a split nozzle, a single solution storage apparatus (10) may be connected to the split nozzle. In the case of a multi nozzle, 2 to 30 solution storage apparatuses (10) may be connected to the multi nozzle.

FIG. 3c shows a schematically illustrated cross-sectional view of a split nozzle part. Referring to FIG. 3c, a split nozzle (30d) is connected to a single solution injection inlet (31d) through which an organic solution is injected from a single solution storage apparatus. The thus injected solution from a single solution storage apparatus passes through a body consisting of cylinders aligned in a row at regular intervals. Each of the nozzles (30d), being connected to a terminal end of each of the cylinders, is aligned in a row at regular intervals. The number of nozzles can be for example in the range of about 2 to about 30, but is not limited thereto. The line spacing of nozzles can be controlled in the range of about 500 nm to about 10 cm. Organic wires arranged in the same direction at regular intervals can be simultaneously fabricated by using split nozzles.

FIG. 3d shows a schematically illustrated cross-sectional view of a multi nozzle part. Referring to FIG. 3d, multi nozzles (30e) are connected to a plurality of solution injection inlets (31e) through which an organic solution is supplied from a plurality of solution storage apparatuses. Each of the thus injected solutions from the plurality of solution storage apparatuses then respectively passes through a body consisting of cylinders. Each of the nozzles (30e) is connected to the terminal end of each of the cylinders. Each of the cylinders and the nozzles is aligned in a row at regular intervals. The number of nozzles can be for example in the range of about 2 to about 30, but is not limited thereto. The line spacing of nozzles can be controlled in the range of about 500 nm to about 10 cm. Organic wires of different kinds arranged in the same direction at regular intervals can be simultaneously fabricated by using multi nozzles.

A voltage applying apparatus (40) is configured to apply high voltage to the nozzles (30), and it can include a high voltage generating apparatus. The voltage applying apparatus (40) may be electrically connected to the nozzles (30), for example, through the solution storage apparatus (10). The voltage applying apparatus (40) can apply voltage in the range of about 0.1 kV to about 50 kV, but is not limited thereto. An electric field is present between the nozzles (30) that high voltage is applied to by the voltage applying apparatus (40), and the grounded collector (50). And by the electric field, droplets formed at the terminal ends of the nozzle (30) form Taylor cones, and organic wires are continuously formed from the terminal ends.

The collector (50) is a part to which organic wires formed from the organic solution discharged from the nozzle (30) are attached. The collector (50) has a flat shape, and is movable on a horizontal plane by a robot stage (60). The collector (50) is configured to be grounded so that it can have a grounding property relative to the high voltage applied to the nozzle (30). Reference numeral 51 indicates that the collector (50) is grounded. The collector (50) can be made of a conductive material, for example, a metal, and have a flatness in the range of about 0.5 μm to about 10 μm (flatness' refers to the maximum error value of a real surface from a perfect horizontal surface when the flatness of a surface with perfect flatness is ‘0’, for example, the flatness of a single surface is the distance between the lowest point and the highest point of the surface).

The robot stage (60) is configured to transport the collector (50). The robot stage (60), configured to be driven by a servo motor, can move at a precise velocity. The robot stage (60) can be controlled, for example, to move in two different directions of x axis and y axis on a horizontal plane. The robot stage (60) may, for example, consist of x axis robot stage (60a), which moves along the x axis, and y axis robot stage (60b), which moves along the y axis. The robot stage (60) may move at intervals in the range of about 10 nm or greater and about 100 cm or less, and preferably, in the range of about 10 μm or greater and about 20 cm or less, but is not limited thereto.

The moving speed of the robot stage (60) can be controlled in the range of about 1 mm/min to about 60,000 mm/min, but is not limited thereto. The robot stage (60) is installed on the base plate (61), and the base plate (61) can have a flatness in the range of about 0.1 μm to about 5 μm. The distance between the nozzle (30) and the collector (50) can be controlled to be at regular intervals by the flatness of the base plate (61). The base plate (61) can provide a precise control over the organic wire patterns by preventing vibrations generated by the operation of the robot stage (60).

The micro distance controller (70) controls the distance between the nozzle (30) and the collector (50). The distance between the nozzle (30) and the collector (50) can be controlled by vertically transporting the solution storage apparatus (10) and the nozzle (30) via the micro distance controller (70).

The micro distance controller (70) may consist of a jog (71) and a micrometer (72). The jog (71) is used for coarse adjustment of a distance in the range of from a few mm to a few cm, whereas the micrometer (72) is used for fine adjustment of a distance in the range of about 10 μm or longer. First, nozzle (30) is neared to the collector (50) by using the jog (71), and then the distance between the nozzles (30) and the collector (50) are precisely adjusted by the micrometer (72). The distance between the nozzle (30) and the collector (50) can be controlled in the range of about 10 μm to about 20 mm. For example, the collector (50), which is parallel to the horizontal X-Y plane, can move on the X-Y plane by the robot stage (60), and the distance between the nozzle (30) and the collector (50) can be adjusted along the direction of Z axis by the micro distance controller (70).

The three dimensional path of nanofibers being spun out of the nozzles in electrospinning was calculated by D. H. Reneker, A. L. Yarin, H. Fong, S. Koombhongse, “Bending instability of electrically charged liquid jets of polymer solutions in electrospinning” J. Appl. Phys., 87, 9, 4531-4546 (2000). According to the above journal article, the greater the distance between the nozzles and the collector, the greater the perturbation of the nanofibers, as shown in the below Equations:

$$\begin{matrix}x = {10}^{- 3} L cos ( \frac{2 π}{λ} z ) \frac{h - z}{h} & Equation ( 1 a ) \\ y = {10}^{- 3} L sin ( \frac{2 π}{λ} z ) \frac{h - z}{h} . & Equation ( 1 b )\end{matrix}$$

In the above Equations, x and y respectively represent the positions in the x axis and y axis directions on a flat plane, L is a constant for a length scale, λ is a perturbation wavelength, z is a vertical position of organic wires relative to collector (z=0), and h is the distance between the nozzles and the collector. From the Equations (1a) and (1b), it is noted that, for the same z value, the greater the distance h between the nozzles and the collector, the greater the values of x and y, which represent the perturbation of the organic wires.

In fact, the organic wires, which are generated from the droplets in the terminal ends of the nozzles and extended therefrom, are almost in the form of a straight line along the direction of z axis, which is perpendicular to the collector, near the nozzles where the organic wires are generated. However, as the organic wires extend farther away from the nozzles, the lateral velocity of the organic wires increases, thereby causing the organic wires to bend.

In an embodiment of the present disclosure, there is provided an electric field aided robotic nozzle printer (100), which can sufficiently reduce the distance between the nozzle (30) and the collector (50) within a range of ten to a few tens of micrometers, thereby causing the organic wires to fall onto the collector (50) before they are perturbed. Accordingly, the organic wire patterns can be formed by the movement of the collector (50).

The formation of the organic wire patterns by the movement of the collector (50) rather than by the movement of the nozzles can reduce perturbation of the organic wire patterns, thereby enabling the formation of more precise organic wire patterns.

Meanwhile, the electric field aided robotic nozzle printer (100) can be installed within a housing (80). The housing (80) can be made of a transparent material. The housing (80) is sealable, and can inject a gas into the housing (80) through a gas injection inlet (not shown). The gas to be injected into the housing (80) includes nitrogen, dry air, and the like, and the injected gas helps to maintain an organic solvent which is readily oxidized in the presence of moisture to be stable. Furthermore, the housing (80) may be provided with a ventilator (81) and a lamp (82). The ventilator (81) and the lamp (82) can be installed in suitable locations. The ventilator (81) is configured to control the steam pressure (generated from a solvent) in the housing (80), thereby controlling the evaporation rate of the solvent at the time of forming organic wires. In a robotic nozzle printing requiring a fast evaporation of a solvent, the evaporation of the solvent can be aided by adjusting the speed of the ventilator (81). The evaporation rate of the solvent may influence the shape and electric properties of the organic wires. When the evaporation rate of the solvent is too fast, it may cause the solution to dry at the nozzle ends before the organic wires are formed, thus clogging the nozzles. In contrast, when the evaporation rate of the solvent is too slow, it prevents formation of solid organic wires, and they may be placed in the collector in a liquid state. The organic solution line in liquid state cannot be used in the manufacture of devices because its electric properties are poor. As such, the evaporation rate of the solvent has an impact on the formation of organic wires and their properties, and thus the ventilator (81) can play an important role in the formation of organic wires.

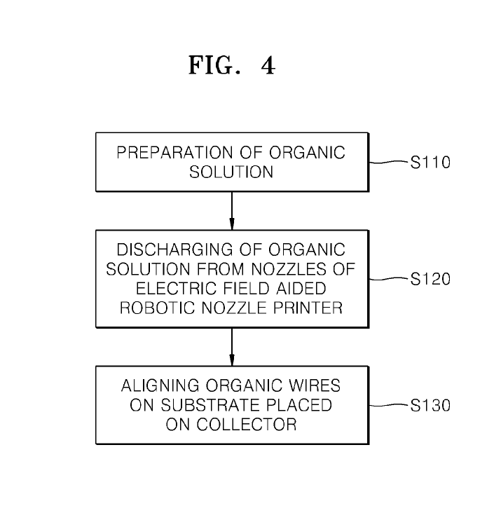

FIG. 4 shows a flow chart illustrating a method of forming organic wire patterns according to an embodiment of the present disclosure.

Referring to FIG. 4, first an organic solution is prepared by mixing the organic material in distilled water or an organic solvent (S110). Examples of the organic material include a low molecular organic semiconductor material, a high molecular organic semiconductor material, a conductive polymer, an insulative polymer or mixtures thereof.

Examples of the low molecular organic semiconductor material include 6,13-bis(triisopropylsilylethynyl)pentacene (TIPS pentacene), triethylsilylethynyl anthradithiophene (TES ADT), and [6,6]-Phenyl C61 butyric acid methyl ester (PCBM), but is not limited thereto. Examples of the high molecular organic semiconductor material or a conductive polymer include a polythiophene derivative, which includes poly(3-hexylthiophene)(P3HT) and poly(3,4-ethylenedioxythiophene) (PEDOT), poly(9-vinylcarbazole) (PVK), poly(p-phenylene vinylene), polyfluorene, polyaniline, polypyrrole, and their derivatives, but is not limited thereto. Examples of the insulative polymer include polyethylene oxide (PEO), polystyrene (PS), polycaprolactone (PCL), polyacrylonitrile (PAN), poly(methyl methacrylate) (PMMA), polyimide, poly (vinylidene fluoride) (PVDF) and polyvinylchloride (PVC)), but is not limited thereto.

Furthermore, these organic materials may selectively include a nano-sized particle, a wire, a ribbon, a rod-shaped semiconductor, a metal, a metal oxide, a precursor of a metal or metal oxide, carbon nanotube (CNT), reduced graphene oxide, graphene, graphene quantom dot, graphite, or a quantom dot where a nano-sized II-VI semiconductor particle (CdSe, CdTe, CdS and the like) forms a core.

The organic solvent, being one used to dissolve the organic material, may include, for example, dichloroethylene, trichloroethylene, chloroform, chlorobenzene, dichlorobenzene, styrene, dimethylformamide, dimethylsulfoxide, xylene, toluene, cyclohexene, isopropyl alcohol, ethanol, acetone or mixtures thereof, but is not limited thereto.

The concentration and viscosity of an organic solution can be controlled to be suitable for being discharged from the nozzle (30) considering the size of the nozzles (30). A substance that can help control the viscosity may be added to the organic solution. Examples of the substances that can help control the viscosity include polyethylene oxide (PEO), poly(9-vinylcarbazole) (PVK), polycaprolactone (PCL), polystyrene (PS), but is not limited thereto.

Then, the organic solution is discharged from the nozzles using the electric field aided robotic nozzle printer illustrated in FIGS. 2a and 2b (S120). The organic solution, where an organic material is mixed with distilled water or an organic solvent, is added into the solution storage apparatus (10), and discharged from the nozzles (30) to thereby form droplets at the end of the nozzle (30). When the nozzle (30) are applied with a voltage in the range of about 0.1 kV to about 50 kV using a voltage applying apparatus (40), the droplets are prevented from being scattered due to the electrostatic force between the charges formed on the droplets and the grounded collector (50) and are increased toward the direction of the electric field, thereby being attached to a substrate (not shown) placed on the collector (50).

Here, as the droplets are increased there may be formed organic wires where a length of one direction from the droplets is longer than that of the other direction. The diameter of the organic wires can be controlled in the range of about 10 nm to about 100 μm by adjusting the applied voltage and the size of nozzles. In the present disclosure, wires less than 1 μm are called nanowires, and wires greater than 1 μm are called microwires.

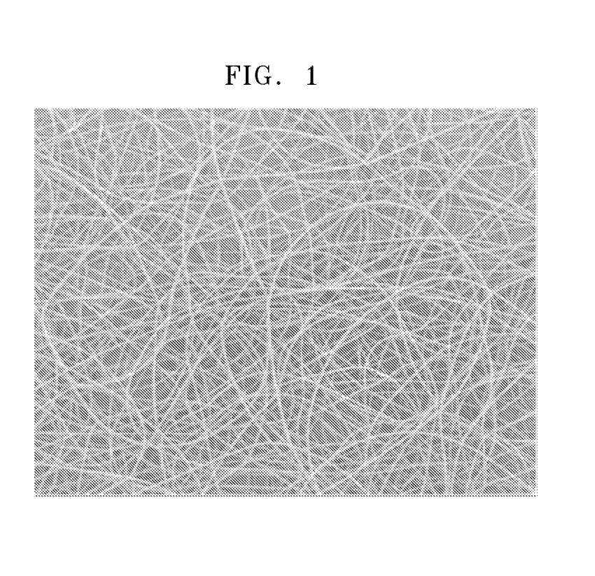

The organic wires formed from the charged and discharged material from the nozzles (30) are aligned on the substrate (not shown) placed on the collector (50)(S130). Here, the organic wires can be formed in a separated state on the collector (50) instead of an intermingled state shown in FIG. 1 by controlling the distance between the nozzle (30) and the collector (50) in the range of about 10 μm to about 20 mm. Here, the distance between the nozzle (30) and the collector (50) can be controlled by using the micro distance controller (70). The substrate (not shown) is used to separate organic wire patterns from the collector. The substrate (not shown) may have a thickness in the range of about 50 μm to about 50 mm. The substrate (not shown) may include a conductive material such as aluminum (Al), copper (Cu), nickel (Ni), iron (Fe), chromium (Cr), titanium (Ti), zinc (Zn), lead (Pb), gold (Au) and silver (Ag); a semiconductor material such as silicon (Si), germanium (Ge) and gallium arsenide (GaAs); and an insulative polymer such as glass, a plastic film and paper, but is not limited thereto.

In addition, by aligning a desirable number of the organic wires in a desirable location by transporting the collector (50), organic wire patterns can be formed on the substrate (not shown) placed on the collector (50). When the aligned organic wires are formed, the collector (50) can be precisely moved by the robot stage (60), which is operated by servo motor, in the range of about 10 nm to about 100 cm.

The organic nanowire patterns aligned according to a method of the present disclosure by using an organic semiconductor material may be applied to electronic devices. For example, high performance nanowire transistors and high sensitivity biosensors can be manufactured by using an organic nano pattern as an active layer of an organic nanowire transistor device and as a detection material for a biosensor.

### Example 1

Poly(9-vinylcarbazole) (PVK) nanowire patterns were formed according to a method of organic wire pattern formation of the present disclosure.

First, PVK (MW: ˜1,000,000) was dissolved in styrene to obtain a PVK solution. The concentration of PVK was 4 wt % relative to the total weight of the organic solution, and the viscosity of PVK was 67.3±5.8 cp (23).

The thus prepared PVK solution was transferred into a syringe of an electric field aided robotic nozzle printer, and PVK solution was discharged from the nozzles while applying 4 kV of voltage to the nozzles. Then, PVK nanowire patterns were formed on the substrate of the collector being moved by the robot stage.

The diameter of the nozzles used was 100 μm, and the distance between the nozzles and the collector was 2.5 mm. The movement space of the robot stage along the Y axis was 50 μm, and along the X axis was 15 cm. The collector size was 20 cm×20 cm, and the size of the substrate on the collector was 2 cm×10 cm.

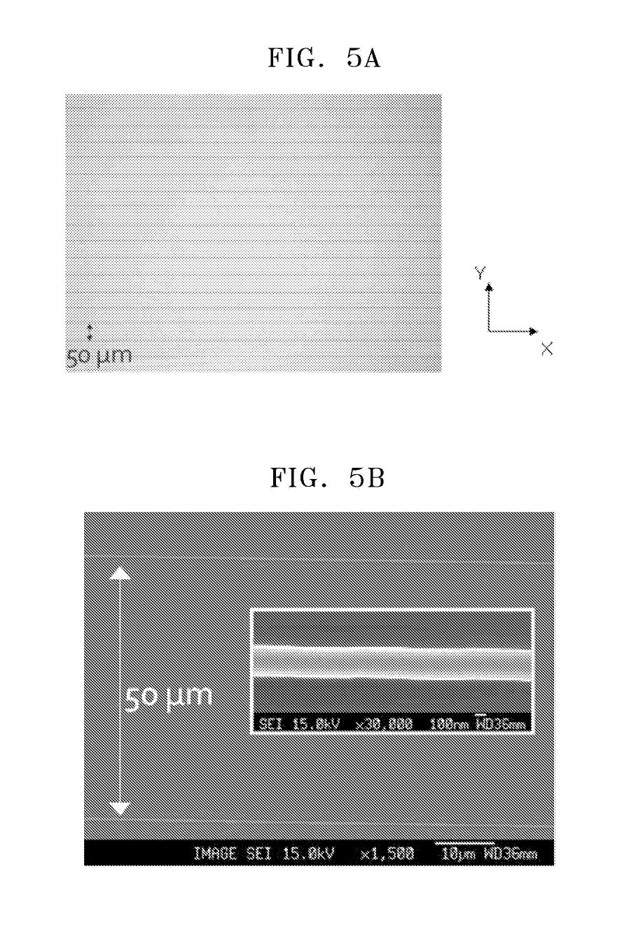

FIGS. 5a and 5b respectively show an optical microscopic picture and a scanning electron microscopy (SEM) picture of organic wire patterns formed according to Example 1.

From the optical microscopic picture of FIG. 5a, it was confirmed that PVK nanowire patterns consist of straight lines being extended along the X axis with a space of 50 μm along the Y axis. The space of the PVK nanowire patterns agrees to the movement space of the collector along the Y axis.

From the SEM picture of FIG. 5b, it was confirmed that the straight lines of PVK nanowire patterns are formed at uniform diameters of about 350 nm, and the line spacing between straight lines is also formed at uniform intervals.

The total length of the PVK nanowire patterns of the present disclosure was about 15 m, and it took about 2 minutes for their formation. Accordingly, it was confirmed that the method of forming organic wire patterns of the present disclosure can be used to efficiently form the organic wire patterns in large area.

### Example 2

The arrangement of a poly(3-hexylthiophene) (P3HT) nanowire field effect transistor (FET) was manufactured according to a method of organic wire pattern formation of the present disclosure. P3HT nanowire pattern as an active layer was formed on the silicon (Si) wafer, which has a doped-Si gate electrode and a silicon oxide film (SiO₂) as a gate insulator film coating with a thickness of 100 nm, and gold was deposited with a thickness of 100 nm thereon via thermal evaporation, thereby forming an electrode.

A mixed powder including P3HT and polyethylene oxide (PEO) (MW: ˜400,000) with 7:3 weight ratio was dissolved in a mixed solution of chlorobenzene:trichloroethylene with 2:1 weight ratio to obtain a P3HT solution. In the P3HT solution, the concentration of the P3HT relative to the entire solution was 2.6 wt %, and that of PEO was 1.1 wt %. The amount of P3HT, PEO, chlorobenzene, and trichloroethylene used was 9.0 mg, 3.9 mg, 223 mg, 111.5 mg, respectively.

The thus prepared P3HT solution was transferred into a syringe of an electric field aided robotic nozzle printer, and P3HT solution was discharged from the nozzles while applying 1.5 kV of voltage to the nozzles. Then, P3HT nanowire patterns were formed on the silicon wafer coated with silicon oxide film over the collector being moved by the robot stage.

The diameter of the nozzles used was 100 μm, the distance between the nozzles and the collector was 5.5 mm, the applied voltage was 1.5 kV, and the discharge rate of a solution was 200 nl/min. The movement space of the robot stage along the Y axis was 5.5 mm, and along the X axis was 15 cm. The movement speed of the robot stage along the Y axis was 1,000 mm/min, and that along the X axis was 30,000 mm/min. The collector size was 20 cm×20 cm, and the size of the substrate on the collector was 8 cm×8 cm.

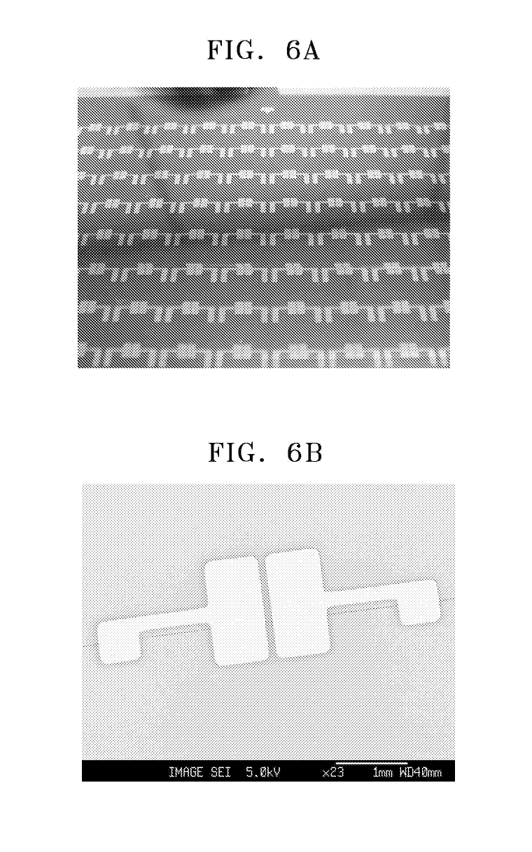

FIG. 6a shows a picture of the arrangement of organic nanowire transistors formed according to Example 2. The P3HT nanowire patterns of the active layer of the transistors arrangement were formed in a single process.

FIG. 6b shows a SEM picture of the arrangement of one of the organic nanowire transistors in FIG. 6a. In the SEM picture of FIG. 6a, there are formed P3HT nanowires below the gold electrode. From this, it can be confirmed that a desirable number of P3HT nanowires are formed in a desirable location. The diameter of the P3HT measured via SEM was about 346.7 nm.

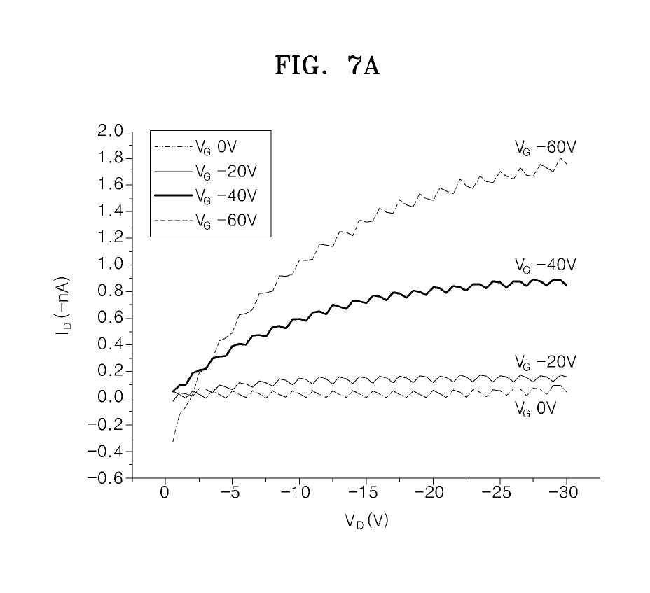

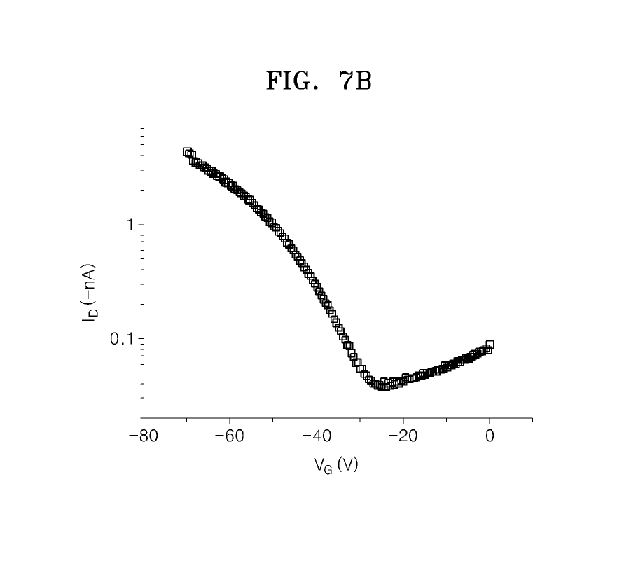

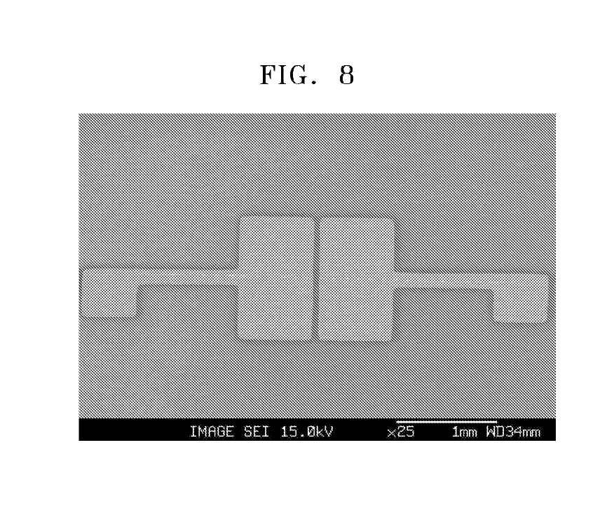

FIG. 7a shows a graph illustrating the measured drain current vs. drain voltage of transistors of FIG. 6a and FIG. 6b. The graph of FIG. 7a shows that, as the absolute value of the gate voltage (VG) increases, there is an increase in the drain current (ID) according to the increase in the absolute value of the drain voltage (VD). FIG. 7b shows a graph illustrating the measured drain current vs. gate voltage of transistors of FIG. 6a and FIG. 6b. In the graph of FIG. 7b, the drain current is relatively low and drops to be below 0.1 nA when the gate voltage is greater than −20 V (i.e., absolute value below 20V), whereas when the gate voltage is lower than −30 V (i.e., absolute value greater than 30V), the drain current is relatively high and increases up to 4 nA. Both the graphs of FIGS. 7a and 7b show the operational characteristics of typical p-type transistors, thus confirming that the transistor of Example 2 is under normal operation.

### Example 3

A P3HT nanowire transistor was manufactured in the same manner as in Example 2 except that P3HT and PEO are mixed in 8:2 instead of 7:3.

FIG. 8 shows a picture of a P3HT nanowire transistor manufactured according to Example 3. Referring to FIG. 8, P3HT nanowires with a diameter of 777 nm are aligned between electrodes.

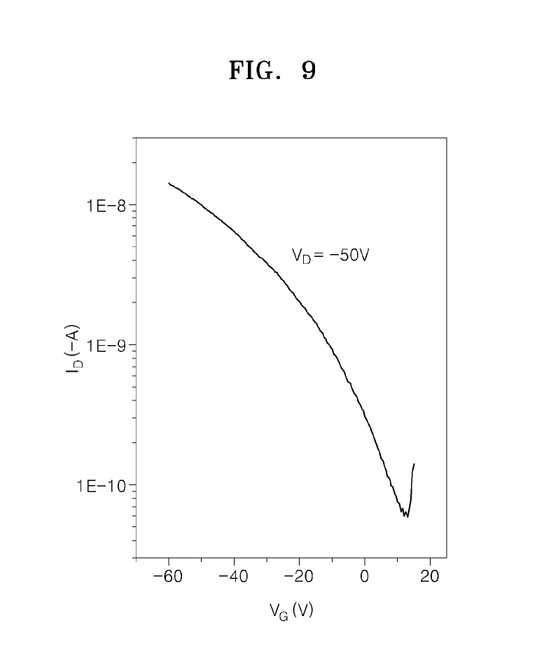

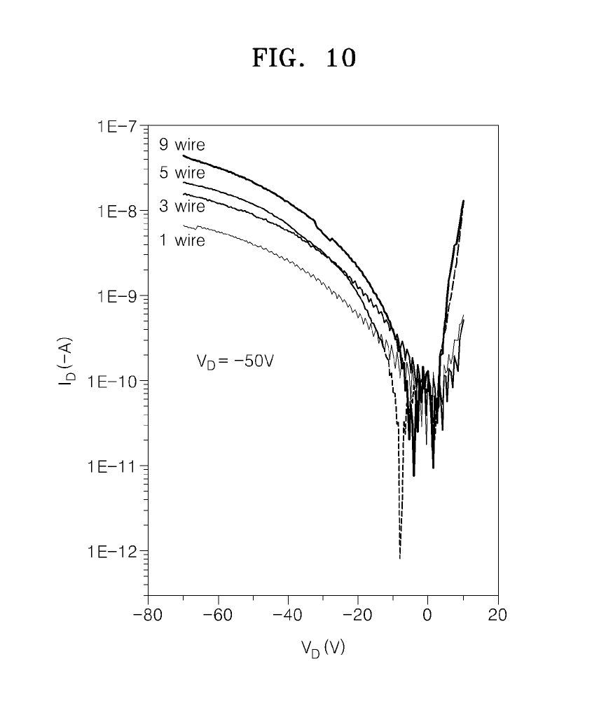

FIG. 9 shows a graph illustrating the measured drain current vs. gate voltage of the transistor of Example 3. The graph in FIG. 9 shows the drain current (ID) measured after applying a drain voltage (VD) of −50V and varying the gate voltage (VG) from 15V to −60V. The graph in FIG. 9 shows that the P3HT nanowire transistor of Example 3 is under normal operation as a p-type FET transistor. Meanwhile, the charge (positive pole) mobility of the P3HT nanowire transistor of Example 3 measured was 0.0148 cm²V·s.

### Example 4

A P3HT nanowire transistor was manufactured in the same manner as in Example 2, except that the number of P3HT nanowires in the FET transistor was varied to 1, 3, 5 and 9.

FIG. 10 shows a graph illustrating the measured drain current vs. gate voltage of the transistor according to Example 4. The graph in FIG. 10 shows that the greater the number of the P3HT nanowires, the greater the entire current, thus confirming that the electric characteristics of a transistor can be controlled by adjusting the number of P3HT nanowires.

1. An electric field aided robotic nozzle printer comprising:
a solution storage apparatus for supplying a discharging solution;
a nozzle for discharging the discharging solution supplied by the solution storage apparatus;
a voltage applying apparatus for applying high voltage onto the nozzle;
a flat and movable collector, in which organic wires formed after discharge from the nozzle are aligned;
a robot stage, which is installed below the collector and enables the collector to move in an X-Y direction within a horizontal plane;
a micro distance controller for regulating a distance between the nozzle and the collector in a Z direction, wherein the Z direction is a vertical direction; and
a base plate that is installed below the robot stage, for maintaining flatness of the collector and preventing vibration from being generated during the operation of the robot stage.

2. The electric field aided robotic nozzle printer according to claim 1, further comprising a discharge controller, which is connected to the solution storage apparatus and discharges the discharging solution in the solution storage apparatus at a predetermined rate.

3. The electric field aided robotic nozzle printer according to claim 2, wherein the discharge controller includes a pump or a gas pressure regulator, and controls the predetermined rate of discharging the discharging solution to be in a range of about 1.0 nl/min to about 50 ml/min.

4. The electric field aided robotic nozzle printer according to claim 1, further comprising a housing that encompasses the solution storage apparatus, the nozzle, the collector, the robot stage, the micro distance controller and the base plate.

5. The electric field aided robotic nozzle printer according to claim 4, wherein an interior of the housing is sealable, and the interior is filled with an inert gas or dry air via a gas injector.

6. The electric field aided robotic nozzle printer according to claim 4, further comprising a ventilator that releases a gas, which is in the interior of the housing, to the outside.

7. The electric field aided robotic nozzle printer according to claim 1, wherein a plurality of solution storage apparatuses is provided, and an separate discharge controller operates independently in the plurality of the solution storage apparatuses.

8. The electric field aided robotic nozzle printer according to claim 1, wherein the solution storage apparatus is made of plastic, glass or stainless steel.

9. The electric field aided robotic nozzle printer according to claim 1, wherein the solution storage apparatus has a capacity volume in a range of about 1 μl to about 5,000 ml.

10. The electric field aided robotic nozzle printer according to claim 1, wherein the nozzle may be a single nozzle, a dual-concentric nozzle, a triple-concentric nozzle, a split nozzle or a multi nozzle.

11. The electric field aided robotic nozzle printer according to claim 10, wherein the dual-concentric nozzle and the triple-concentric nozzle respectively receive a discharging solution from ones of a plurality of the solution storage apparatuses.

12. The electric field aided robotic nozzle printer according to claim 10, wherein about 2 to about 30 split nozzles are aligned in a row at predetermined intervals and receive a discharging solution from a single solution storage apparatus.

13. The electric field aided robotic nozzle printer according to claim 10, wherein about 2 to about 30 multi nozzles are aligned in a row at predetermined intervals and respectively receive a discharging solution from ones of a plurality of the solution storage apparatuses.

14. The electric field aided robotic nozzle printer according to claim 1, wherein the nozzle has a diameter of about 100 nm to about 1.5 mm.

15. The electric field aided robotic nozzle printer according to claim 1, wherein the applied high voltage to the voltage applying apparatus is in a range of about 0.1 kV to about 50 kV.

16. The electric field aided robotic nozzle printer according to claim 1, wherein the collector is grounded and has a flatness of about 0.5 μm to about 10 μm.

17. The electric field aided robotic nozzle printer according to claim 1, wherein the robot stage is movable in a range of about 10 cm to about 100 cm.

18. The electric field aided robotic nozzle printer according to claim 1, wherein a velocity of the robot stage movement is controlled in a range of about 1 mm/min to 60,000 mm/min.

19. The electric field aided robotic nozzle printer according to claim 1, wherein the micro distance controller includes a jog and a micrometer, and the distance between the nozzle and the collector is controlled in a range of about 10 μm to about 20 mm.

20. The electric field aided robotic nozzle printer according to claim 1, wherein the base plate has flatness of about 0.1 μm to about 5 μm.

21. A method of fabricating organic wire patterns comprising,
adding an organic solution, in which an organic material or an organic-inorganic hybrid material is mixed with distilled water or an organic solvent, into the solution storage apparatus of the electric field aided robotic nozzle printer according to claim 1;
discharging the organic solution from the nozzle while applying the high voltage on the nozzle by using the voltage applying apparatus of the electric field aided robotic nozzle printer; and
aligning, on a substrate placed on the collector while transporting the collector, the organic wires formed after the discharge from the nozzle or organic-inorganic hybrid wires formed from the organic solution being discharged from the nozzle.

22. The method of fabricating the organic wire patterns according to claim 21, wherein the organic material includes a low molecular organic semiconductor material, a high molecular organic semiconductor material, a conductive polymer, an insulative polymer or mixtures thereof.

23. The method of fabricating the organic wire patterns according to claim 21, wherein the organic material includes,
a low molecular organic semiconductor material selected from the group consisting of 6,13-bis(triisopropylsilylethynyl) (TIPS pentacene), triethylsilylethynyl anthradithiophene (TES ADT) and [6,6]-phenyl C61 butyric acid methyl ester (PCBM);
a high molecular organic semiconductor material or conductive polymer selected from the group consisting of poly(3-hexylthiophene)(P3HT), poly(3,4-ethylenedioxythiophene) (PEDOT), poly(9-vinylcarbazole) (PVK), poly(p-phenylene vinylene), polyfluorene, polyaniline, polypyrrole, and their derivatives; and
an insulative polymer selected from the group consisting of polyethylene oxide (PEO), polystyrene (PS), polycaprolactone (PCL), polyacrylonitrile (PAN), poly(methyl methacrylate) (PMMA), polyimide, poly (vinylidene fluoride) (PVDF) and polyvinylchloride (PVC).

24. The method of fabricating the organic wire patterns according to claim 21, wherein the organic-inorganic hybrid material is at least one selected from the group consisting of a nano-sized particle, a wire, a ribbon, a rod-shaped semiconductor, a metal, a metal oxide, a precursor of a metal or metal oxide, carbon nanotube (CNT) or reduced graphene oxide, graphene, graphene quantom dot, graphene nanoribbon, graphite, and a quantum dot in which a nano-sized II-VI semiconductor particle forms a core

25. The method of fabricating the organic wire patterns according to claim 21, wherein the substrate includes a conductive material selected from the group consisting of aluminum (Al), copper (Cu), nickel (Ni), iron (Fe), chromium (Cr), titanium (Ti), zinc (Zn), lead (Pb), gold (Au) and silver (Ag); a semiconductor material selected from the group consisting of silicon (Si), germanium (Ge) and gallium arsenide (GaAs); and an insulative polymer selected from the group consisting of glass, a plastic film or paper.

26. The method of fabricating the organic wire patterns according to claim 21, wherein line spacing of the organic wires is in a range of about 10 nm to about 20 cm.
